(19) United States
(12) Patent Application Publication
(10) Pub. No.: US 2002/0148408 A1
(43) Pub. Date: Oct. 17, 2002

(54) Milk flow monitor and milker unit detacher

(76) Inventors: Brion Gompper, Onalaska, WI (US); Kevin Keeffe, La Crosse, WI (US); Steven H. Kulig, Ettrick, WI (US)

Correspondence Address: LATHROP & CLARK LLP, 740 REGENT STREET SUITE 400, P.O. BOX 1507, MADISON, WI, 537011507

(21) Appl. No.: 09/993,310

(22) Filed: Nov. 5, 2001

Related U.S. Application Data
(63) Continuation of application No. 09/161,836, filed on Sep. 28, 1998, now abandoned.

(51) Int. Cl. A01J 3/00; A01J 5/00

(52) U.S. Cl. 119/14.14

(57) ABSTRACT

A milk monitor with a sensor positioned near the milker unit to monitor milk conditions and adjust a variety of dairy facility operations in response to milk conditions. The milk monitor is programmable to provide flexibility, real-time adjustment of dairy operations, and trend analysis and control to optimize milk production and herd health.

This application is a continuation of U.S. application Ser. No. 09/161,836 filed Sep. 28, 1998, the disclosure of which is incorporated by reference herein.

### FIELD AND BACKGROUND OF THE INVENTION

The present invention relates generally to a computer-implemented milk monitor for a dairy harvesting facility, and more particularly, to a milk sensor for monitoring the condition of milk from livestock being milked and an activity-based controller that reacts to the milk condition by controlling dairy facility operating parameters. The sensor acquires data about the milk that is converted to signals that are converted by the activity-based controller to dairy system control parameters that: control milking times; warn operators of adverse milking conditions; interface with other dairy system modules such as vacuum systems, utilities, milk cooling and storage, and chemical dispensers; or are able to transfer data to archives for use by the dairy operator, equipment and maintenance dealer, or equipment manufacturer.

Presently, dairy harvesting facilities do not monitor milk flow to control a multitude of dairy facility operations. Some facilities make limited use of milk flow data for use with automatic milker detachers that are controlled by milk meters, timers, or by an operator who monitors milking progress visually. The milkers are detached when milk flow from a cow indicates that the cow has reached the end of its milk cycle or when a predetermined time has elapsed.

When detecting the end of milk cycle automatically, it is possible to use any one of numerous types of flow meters that generate and send a signal to an automatic detacher unit. Some detachers include a printed circuit board with pre-programmed instructions or parameters defining a time and/or flow rate indicative of when a cow has finished milking. When the measured milk flow rate is within a certain flow range, the detacher automatically detaches the milker. Similarly, when the end of the milking cycle is detected visually, the operator uses experience and judgment to determine whether a particular cow has finished milking. Other milk flow monitors use pre-programmed circuit boards as part of the milking system to control vacuum in the milking system over the course of the milking cycle.

The current methods used to milk cows or detect the end of the milk cycle fail to accommodate the unique characteristics of individual cows. Milk production from cow to cow and even cow udder quarter to quarter is not uniform as FIGS. 4 to 11 illustrate.

In FIG. 4 the actual flow rate of milk from Cow A is plotted relative to time as measured by an optic sensor. The data obtained from the optic sensor has been used to generate a curve-fit algorithm to plot the illustrated curve. The flow rate shows an initial surge in milk flow for about the first 50 seconds or so and then flow stops for a few seconds. Within the next quarter minute the flow rate increases dramatically and then ramps down at varying rates about the four and a half minute mark where the milk cycle is completed.

FIG. 5 plots milk weight obtained over time for Cow A. The curve illustrates that within the last minute and a half of milking the yield is only about two and a half to three pounds out of the total twenty-one pounds of milk. Thus, 33% of the milking cycle is used to obtain about 12% of the milk.

Next, FIG. 6 plots milk flow rate versus time for Cow B. Although similar in shape, the flow rate curves for Cows A and B have substantial differences in the size of the initial first-minute surge of milk and the degree in drop off at the end of that first minute. Also, the jump in production after the first minute is not as steep for Cow B and the following reduction in milk flow is more gradual. The milking time for Cow B is six minutes versus four and a half minutes for Cow A. These two curves show dramatic differences between Cows A and B to obtain the same quantity of milk.

FIG. 7 illustrates that a disproportionate amount of milk time at the end of the milk cycle is necessary to obtain a relatively small amount of milk. Since most of the milk is obtained in the first three minutes.

Curves of these types vary with every cow, cow quarter, and over time for the same cows. The charts above illustrate curves generated to fit optic sensing data FIGS. 4 and 6, and milk production data FIGS. 5 and 7. Below are additional charts illustrating actual data curves for milk let-down. The data points on these charts occur more frequently than in the charts above and were obtained with milk weighing devices, as opposed to an optic sensor, that provide milk production rates. FIGS. 8 to 11 further illustrate the dramatic differences in milk let down from cow to cow.

FIG. 8 shows an actual milk let-down curve and milk productions and times for cow no. 2092; FIG. 9 shows a curve and production for cow no. 4222; FIG. 10 shows a curve and production for cow no. 3729; and FIG. 11 shows a curve and production for cow no. 2095.

These figures further illustrate how dramatically milk production, milking times, milking rates, and milking rate differentials vary from cow to cow. FIG. 8 shows about a five minute milking time, 25.4 pounds of production, five pound per minute average flow rate, and a peak flow of about seven pounds per minute. Flow rate started low (about 2 lbs/min) and increased gradually to about the peak flow rate before tapering off in the last third of the milking cycle.

FIG. 9 shows a lower producing cow (18.5 lbs) milked in just about three minutes, with an average flow rate of about six pounds per minute and a peak at over nine pounds per minute. Milk production started higher (about 4.5 lbs) and varied around 8 lbs/min before tapering off in the last third of the milking cycle.

FIG. 10 is a higher producing cow (39.75 lbs) that milked out in just under six minutes with an average flow rate of 6.74 lb/min and a peak of over 10.5 lbs/min This cow started milking out high (about 9.0 lbs/min) and remained at or above that level for about the first half of the milking cycle before ramping down.

Last, FIG. 11 shows an extremely high producing cow (50 lbs) that took over nine minutes to milk, with average flow rates of about 5.5 lbs/min and a lower peak (7.43 lbs/min) that in FIG. 10. The curve for this cow is very different than others shown above. The cow starts out slowly, but quickly rises to a six to seven pounds rate for several minutes. Then milk production drops off to nearly a pound per minute before recovering to a nearly peak rate again.

While these variances in let-down curves have always been known to dairy farmers, no mechanisms or procedures have ever been developed to optimize milking for individual cows. Optimizing milking for cows can obtain higher yields from each cow, thereby making it possible to sustain current outputs with fewer cows. Fewer cows results in lower capital requirements, healthier herds, reduced manpower, and shorter milking times.

In large dairy herds it may be possible to use a programmable read-only-memory (PROM) milker controller or detacher to obtain acceptable yields from most of the cows, but many cows will not provide optimum yields under the “average” milking conditions that must be assumed in the PROM. In small dairies, the cow-to-cow variations in milk flow curves will be more pronounced and finding an optimum milking cycle for most cows will be more difficult.

The above charts illustrate milking cycles for each cow combining all four quarters of the cows' udders. It is known that each quarter of a cow udder can have a milking cycle that varies with respect to other cow udder quarters. Thus, the optimum milking cycle issue is magnified four-fold when quarters are being monitored.

To accommodate different milk cycles, milking times and milking practices vary among dairies. Dairies typically milk twice or three times daily, and four times milking is not uncommon. As the number of daily milkings increases, it is less important to completely milk out each cow at each milking because it will not unduly stress a cow to have residual quantities of milk in her udder for shorter periods of time. Thus, it may be desirable to increase the number of milkings and decrease the amount of time spent in the dairy parlor.

It is also believed by some that leaving some milk in the cow (“milking wet”) is beneficial to cow health. Just how much is enough to benefit from wet milking depends on the number of daily milkings and may change depending upon other conditions such as feed, weather, time of day, other cow health issues, etc. Thus, using any rigid milking standard or cycle cannot simultaneously optimize cow yields and cow health, nor can a simple operator interface that can override preprogrammed milking instructions, because the interface can not re-program the system.

The milk flow conditions through a milk flow meter do not necessarily indicate an ideal time to end the milk cycle for all cows or all dairies. In fact, since all cows and even cow udder quarters on the same cow are different, some dairy operators have different definitions of when a cow's milking cycle has ended. For example, some dairies milk cows until no milk remains in the cow's udder, a procedure known as milking the cow “dry”. Other dairies stop milking cows when there is still some milk remaining in the cow's udder, a procedure known as milking the cow “wet”. To accommodate both types of milking conditions, an automatic detacher unit controlled by a PROM would have to include at least two preprogrammed sets of instructions to accommodate both types of dairies. Further complicating matters is that there are varying degrees of wet milking dairy operators believe to be best. Still other dairies set milking time to obtain about the same quantity of milk that has been automatically or manually recorded for individual cows from past milkings.

Additional considerations used to determine when to detach a milker unit from a particular cow can include the following: cow or cow udder quarter milking histories; milking time of day; weather conditions; feed conditions; cow lactation cycles; cow breeding cycles; number of daily milkings; milking parlor throughput goals; cow and cow herd health; milking vacuum control; and any additional factors that affect milking rate and animal health within the dairy. Obviously, these conditions vary over time and no pre-programmed printed circuit board can possibly accommodate the infinite number of variable combinations that a particular automated detacher unit may be called upon to consider in any particular dairy to accommodate that particular dairy's needs.

Recognizing the inflexibility of pre-programmed automatic detachers, some manufacturers include an override option that permits an operator to disregard preprogrammed milking instructions and milk longer or shorter if desired. This is less than desirable, because if a cow is left unattended during an extended override milking period, the cow can be unnecessarily stressed and teat damage can occur. Such occurrences are not uncommon in large dairies where many cows are milked simultaneously and operator attention is often diverted. Automatic detachers lose their advantages when override abuses occur and the override can not be used to vary milking instructions.

Dairy throughput is also adversely affected by present detacher systems, that do not have the ability to deal with the large number of variables affecting milking production. A system that milks each cow to completion can cause delays in throughput because some cows will be finished milking before others in their milking group, but no new cows are brought in until all the cows in that group have finished milking. This delay is unnecessary when the last quarter, to one third of the milking cycle is a time of diminishing returns for milk production. Even if an operator decides to override automated milking, each machine must be detached separately, rather than detaching all milking machines in unison.

Further, milking data acquisition is becoming increasingly important. To optimize herd health and milk production some dairy systems obtain milk production data and archive it automatically so that, over time, milking conditions and other dairy operations can be adjusted. The data currently being collected is monitored on a regular basis, but milk production histories from a previous month, week, or even day will not provide complete and timely information about milking conditions or cow health. Nor does such a milk production history provide information about milking cycle rates, daily changes in feed, weather, milking time of day, cow health, and so on. Also, this data is merely stored for later analysis. No attempt is made to use it for real-time control of milking times, vacuum control, or optimizing milk yield. Thus, prior data acquisition systems do not provide enough versatility to adjust to constantly changing factors affecting herd health and milking conditions.

Some existing cow identification systems alert operators when a cow in the milking parlor should not be milked or requires special attention. Other identification systems prevent or interrupt milking when a sick cow is identified. Nonetheless, even these systems do not interact with other dairy components to modify milking conditions, such as pulsation rate and ratio for particular cows, or redistribute milk from sick cows to alternate storage or to waste.

With regard to dairy systems management and interaction of dairy subsystems or modules, it has been suggested (although not commercialized) that a computer-based system could be used to interface and exchange data for optimizing yields and dairy system management. However, no suggestion has been made to use milk monitoring as a central node or module upon which milking and diagnostics are optimized and other dairy system modules are subservient.

Thus, there is a need for a milk monitoring device having an activity-based controller such as a data processor that can be used to vary milker detacher instructions based on any of the above-described conditions. There is also a need for milk monitoring device having a data archive for archiving information on individual cows within a dairy so that detacher instructions can be adjusted in real-time to accommodate the needs or milking history of particular cows. There is also need for a milk monitor having an activity-based controller that can translate data acquired from a sensor unit to a warning signal for alerting a dairy operator of a problem or for adjusting milking instructions. There is also in need for a milk monitor having an activity-based controller that can convert data from the sensor and interface with other dairy operations to either adjust the other dairy operations or, on the other hand, convert data received from the other dairy operations to adjust dairy system control parameters.

There is also a need for a milk monitor with an activity-based controller that allows easy operator interface to change dairy system control parameters for the whole herd, groups of cows, or individual cows. The interface should also inform an operator any of numerous conditions during the milking cycle and in particular, should direct an operator to take any action necessary to ensure the best possible health of the cows being milked while optimizing milk yield.

There is also a need for a milk monitor with a data acquisition system that transmits milking data in an upward mobility path to operators, equipment dealers, and manufacturers to optimize maintenance procedures, improve product delivery timing, and constantly improve milking conditions to ensure herd health and high milk yields.

### SUMMARY OF THE INVENTION

The present invention provides a computer-implemented milk monitor, including: a milk sensor for generating signals corresponding to a condition of milk flow from a cow being milked; and an activity-based controller for receiving signals from the milk sensor and delivering a milk facility control parameter to a milk facility interface. The activity-based controller can include an operator interface, a fuzzy logic processor, or any data processor that is programmable by the operator to provide maximum flexibility to vary dairy operating parameters and automatically make adjustments to dairy system modules for consistency or to optimize dairy operations. A programmable system permits an operator to experiment or rely on fuzzy logic to attain these goals since no two dairies are the same and no single milk monitoring system, pre-programmed or otherwise, will provide the flexibility of the present invention.

The computer-implemented milk monitor having the fuzzy logic processor may be coupled to a data archive and when this is the case the milk facility parameters are responsive to trends in the data archived for the cow being milked or any other input and archived data, such as would be apparent in comparisons between the milk sensor signals and the archived data.

The milk facility interface is a generic term to be used to describe an interface with any dairy system module such as a milker detacher, and the milk facility control parameter for that module will have a corresponding function such as a parameter that controls the milk detacher timing in the milker detacher module. Other examples include: a milk facility interface coupled to a vacuum rate and ratio controller with the milk facility control parameter controlling the rate and ratio of milking vacuum; a milk facility interface coupled to a dairy wash system with the milk facility control parameter controlling the timing of the milk line wash cycle; a milk facility interface coupled to a milk chiller with the milk facility control parameter controlling milk chilling operations; a milk facility interface coupled to a bulk storage tank with the control parameter controlling bulk tank operations; a milk facility interface coupled to a sort gate with the milk facility control parameter controlling the sort gate; a milk facility interface coupled to a feed system with the milk facility control parameter controlling the feeding of the cow being milked; a milk facility interface coupled to a data archive with the milk facility control parameter accessing data archives corresponding to a cow or cows being milked; and/or a milk facility interface coupled to an upstream data channel with the milk facility control parameter transmitting data to an upstream communications channel with the control parameter controlling what data is transmitted upstream and to whom the data is transmitted.

The computer-implemented milk monitor can also receive sensor signals from sources other than the milk sensor corresponding to the cow being milked. For example, the monitor's activity-based controller can be coupled to (1) an ambient condition sensor for generating and sending ambient condition signals to the activity-based controller for use in generating and delivering milk facility control parameters to one or more milk facility interface; (2) a second milk sensor for generating and sending signals corresponding to a condition of milk flowing from a second cow being milked so the activity-based controller receives signals from the second milk sensor to deliver milk facility control parameters to one or more milk facility interfaces; (3) a cow identifier for activating milk facility control parameters corresponding to the cow being milked; (4) a data archive corresponding to individual cows for use with a cow identifier for generating a signal corresponding to the data archive corresponding to the identified cow for activating milk facility control parameters corresponding to that cow; and/or (5) any dairy system module that interfaces with the activity-based controller so that control parameters to that or, any other module can be changed based on data received from the modules.

The computer-implemented milk monitor can further include an override to the milk facility control parameters activated by the activity-based controller and there may also be included a control parameter from the activity-based controller that re-generates and transmits milk facility control parameters after a predetermined lapse of time after the manual override begins.

The activity-based controller may be a coupled to a plurality of dairy harvesting facility interfaces for delivering and receiving control parameters or other data transmitted through an interface. The sensor signals from the plurality of dairy harvesting facility interfaces so that one change to dairy operations can result in an activity-based controller adjusting one or more modules in the dairy system.

The milk sensor can be a milk flow rate meter; a mastitis detector; an estrus detector; a milk fat content monitor; a contaminants detector; or a combination of one or more of the above.

As stated earlier, the activity-based controller can include a fuzzy logic processor or an operator programming interface, which can be a central operator interface controlling a plurality of milker detachers or a central operator interface controlling a of plurality of dairy system components.

In another embodiment of the present invention there is provided a milk monitor having a data processor that can be programmed with instructions for controlling a milker detacher based on any of numerous parameters affecting milk yield and herd health. The instructions may be input by the dairy operator or varied according to data signals from: a corresponding milk sensor; from milk sensors corresponding to other cows being milked or from other dairy operations; milking history and health data stored in archives for a particular cow being milked; and/or data signals from monitoring ambient conditions. The data processor provides real-time flexibility in milking and herd health management, the ability to customize a dairy's milking operations, and the ability to interface with other components of the overall dairy system. Data processors, fuzzy logic processors, or an operator interface also provide the ability to distribute milking information in an upward mobility path to operators, suppliers, maintenance personnel, and manufacturers to improve equipment and dairy operations.

The present invention also provides for storing an initial set of milking instructions on an activity-based controller; monitoring milk from a cow or cow udder quarters; and controlling cow milking time, milking vacuum, cow movement, and other factors relating to dairy facility management in response to dairy facility parameters received from the activity-based controller.

The present invention can be used to detach all cows that are being milked after a predetermined number of the cows are finished milking, the invention can further identify individual cows as “slow milkers” when the milking machines were detached before a cow was finished milking; and identify individual cows as “fast milkers” when the milking machines were detached at or after a cow was finished milking. Using this information, the slow milker cows can be sorted from the fast milker cows using sort gates that are controlled by dairy facility control parameters transmitted by an activity-based controller. In this manner, it is possible to group the sorted slow milker cows with slow milker cows from a second group for subsequent milking operations to improve dairy throughput.

Within the scope of the invention it is possible to vary the milk time of a group of cows in response to cow feed data, weather data, milking frequency, time of day, lactation cycle data for individual cows, and breeding cycle data for individual cows.

### BRIEF DESCRIPTION OF THE DRAWINGS

FIG. 1 is a schematic drawing of a dairy facility having an activity-based controller in accordance with the present invention.

FIG. 2 is an automatic milker detacher with a milk monitoring sensor for each cow quarter.

FIG. 3 is a diagram of a milk monitoring and control system in accordance with the present invention.

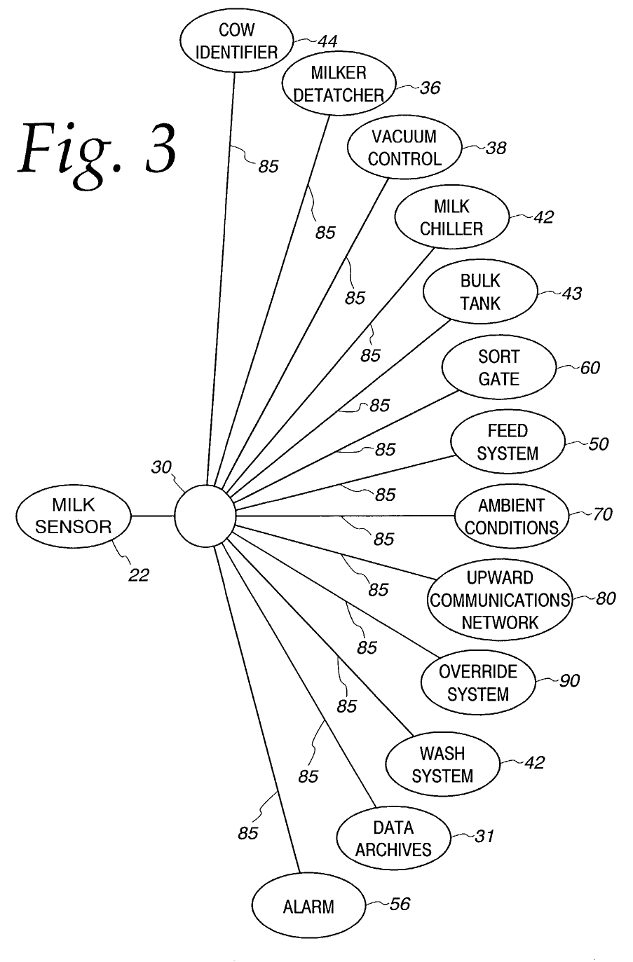

FIG. 4 is a chart recording test data of milk flow rate over time of milking.

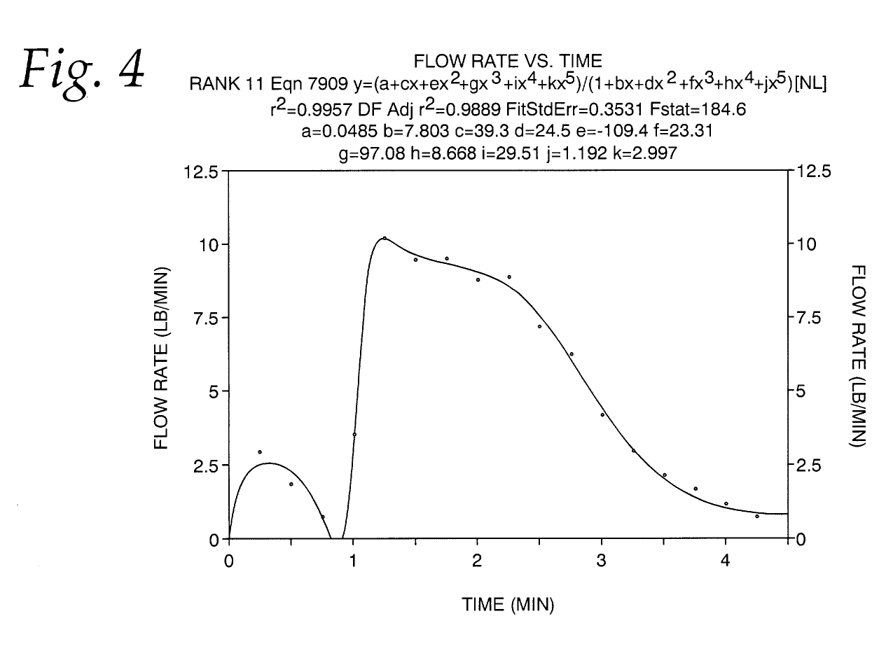

FIG. 5 is a chart recording test data of milk weight over time of milking.

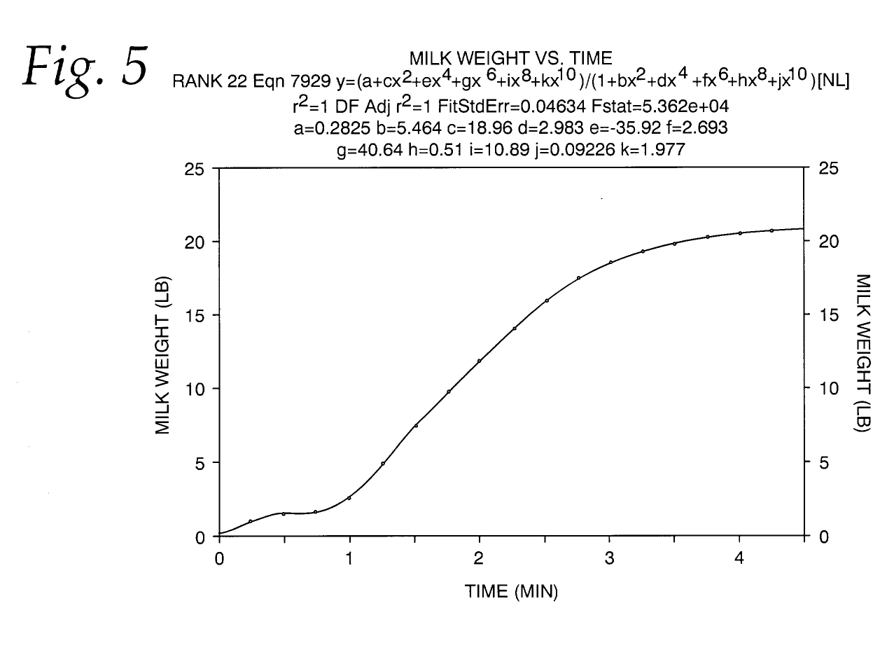

FIG. 6 is a chart recording test date of milk flow rate over time of milking.

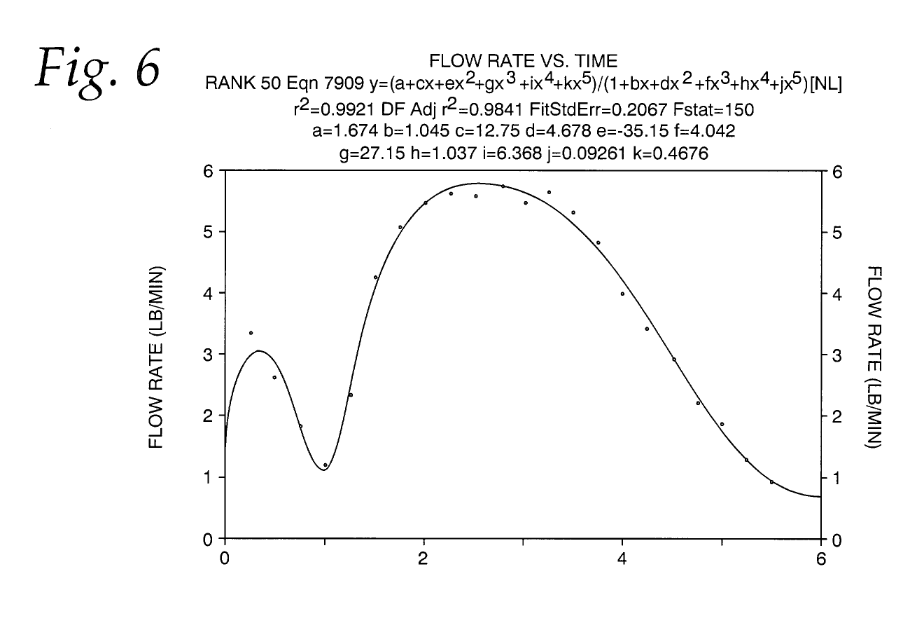

FIG. 7 is a chart recording test data of milk weight over time of milking.

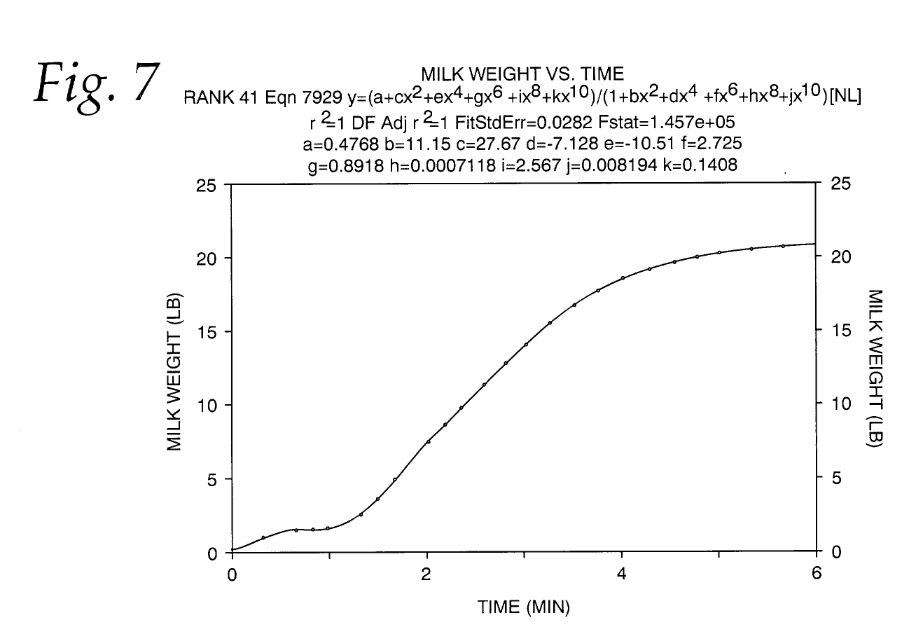

FIG. 8 is a chart recording test data of milk flow rate over time of milking.

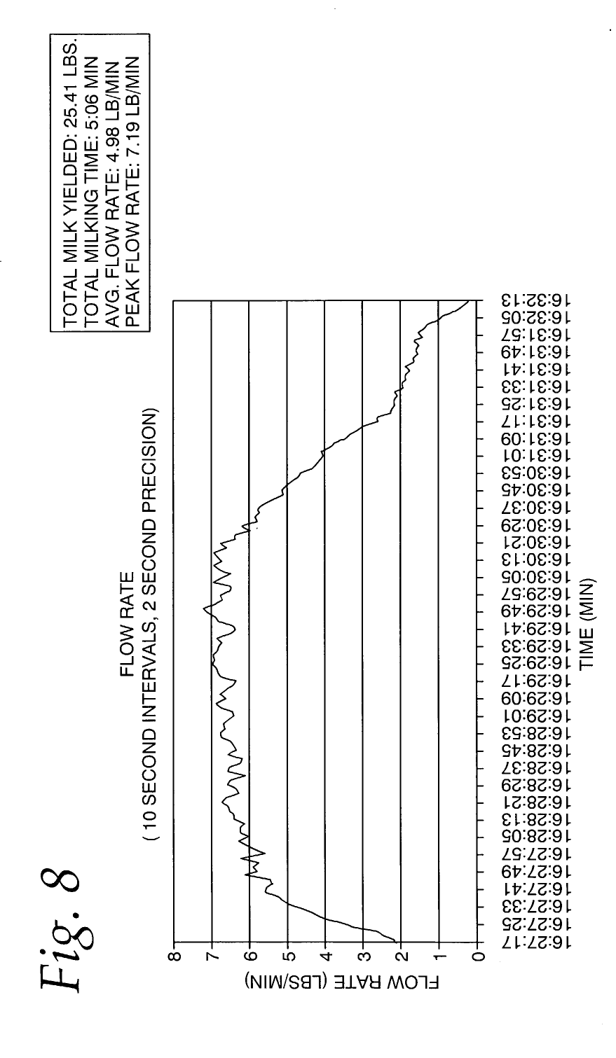

FIG. 9 is a chart recording test data of milk flow rate over time of milking.

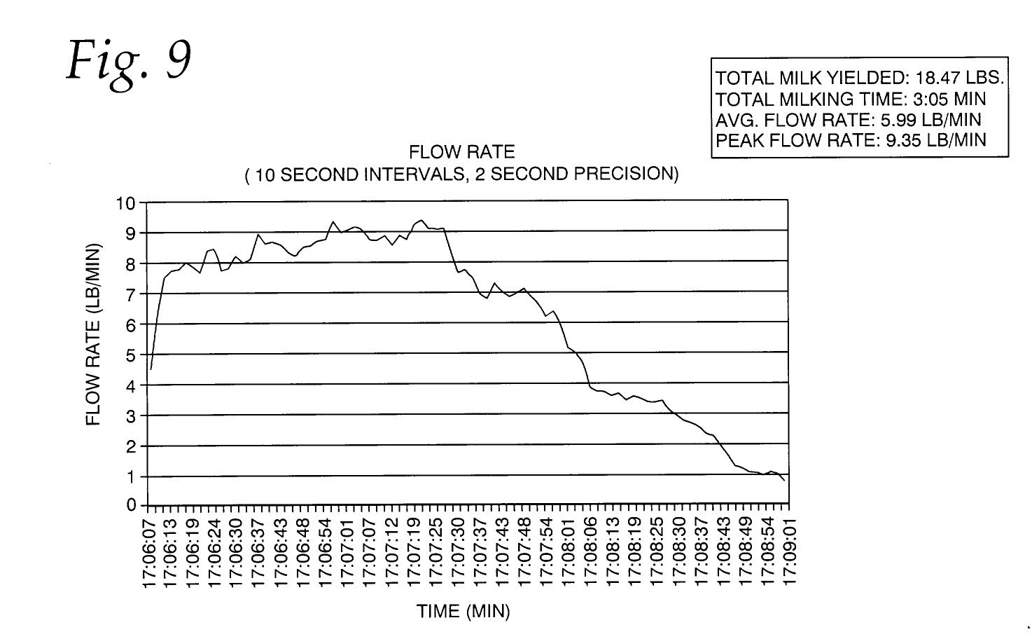

FIG. 10 is a chart recording test data of milk flow rate over time of milking.

FIG. 11 is a chart recording test data of milk flow rate over time of milking.

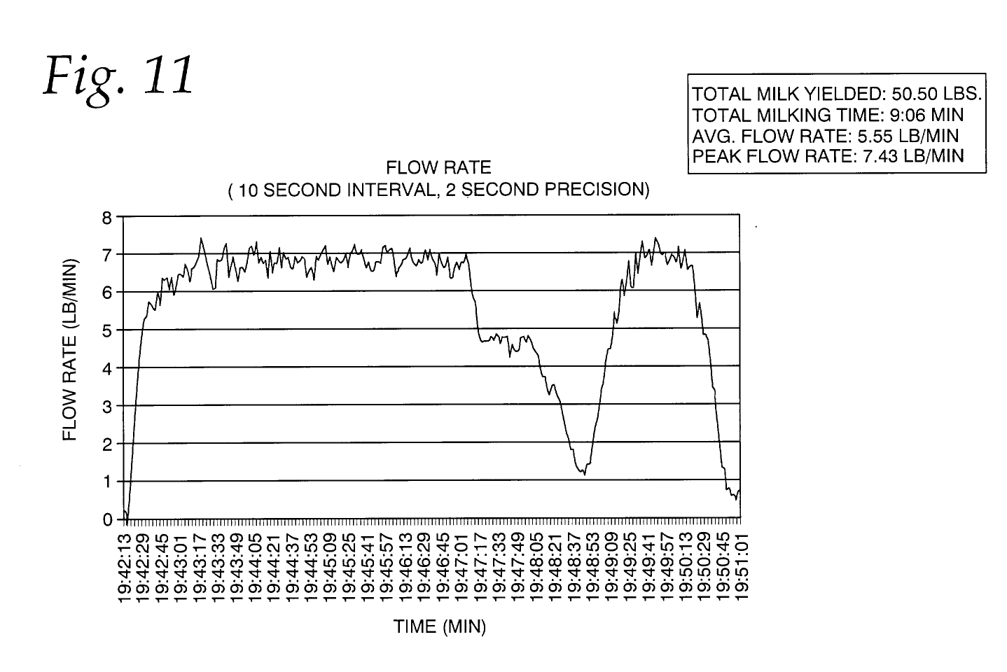

### DETAILED DESCRIPTION OF THE INVENTION

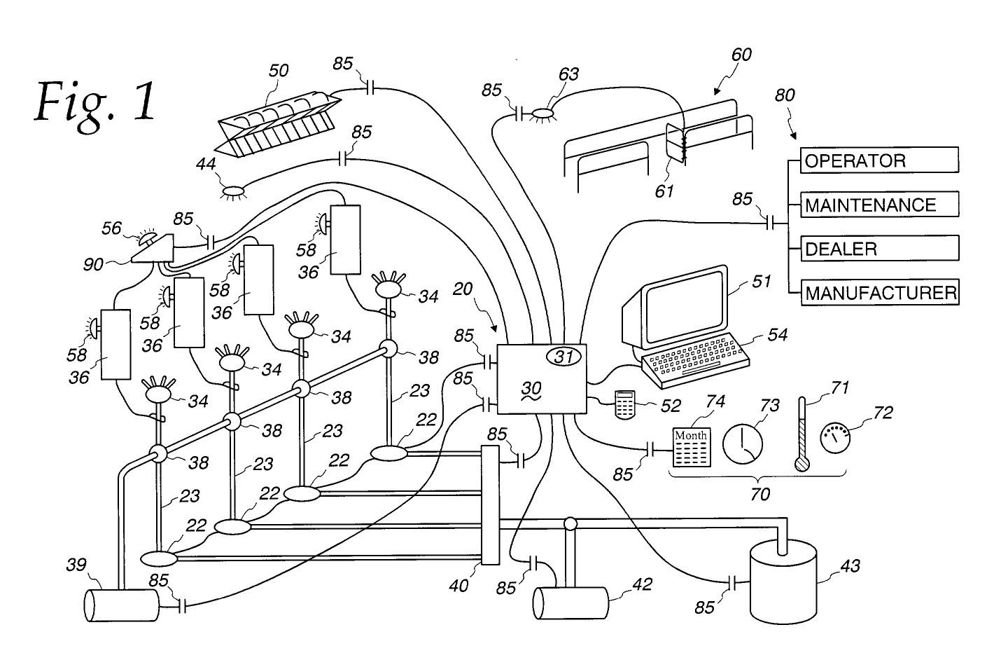

The present invention as illustrated in FIG. 1 comprises a computer-implemented milk monitor 20, for receiving milk data or other information from a milk sensor 22 and converting the signals to generate dairy system control parameters that are sent to a dairy system interface and be transferred to a dairy system module to control the module. The milk monitor 20 comprises an activity-based controller 30 that interfaces with and controls modules in a dairy system where the modules can include milkers 34, detachers 36, vacuum regulators 38, a vacuum pump 39, a milk chiller 40, a bulk tank 42, cow identifiers 44, feed systems 50, sort systems 60, ambient condition monitors 70, or an upward mobility communications network 80. Other dairy system components or modules are also capable of interfacing with the monitor at interfaces 85.

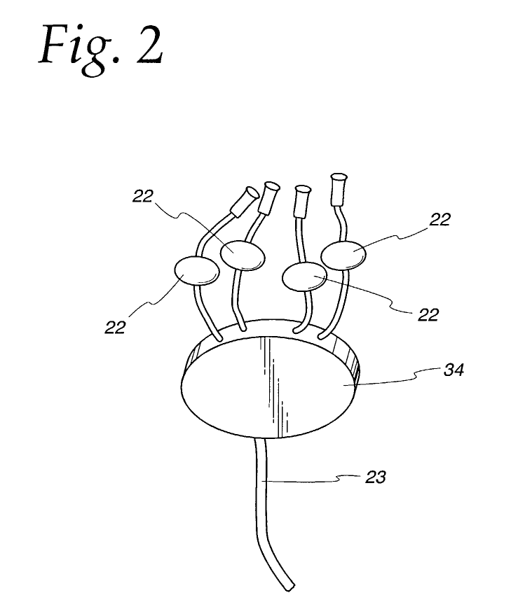

The milk sensor 22 may be a milk meter on each milk line 23 or each cow quarter milk line (FIG. 2), or it can be an optic or ultrasonic flow meter, fat content meter, etc. Other suitable milk sensors 22 include mastitis detectors, or other diagnostic device that measures or notes estrus cycles, contaminants, etc. which may affect milk production and cow health.

Preferably, the cows or other livestock to be milked are identified automatically by a cow identifier 44 as they enter the milking parlor or individual stalls. The identification is transmitted to the activity-based controller 30 to access an appropriate archive for each cow, cow quarter, or group of cows. The archive should indicate first whether the cow is to even be milked at all. This is important should a sick cow enter the milking parlor even though it should not be milked or it should be milked under restrictive or isolated conditions. If a cow with severe mastitis, for example, were to be milked and the milk sent to a bulk tank 44, all of the milk in the bulk tank 44 could be contaminated and consequently lost. Thus, the invention can provide a first screen of all cows before a problem arises.

As each cow is milked, the milk sensor 22 continuously monitors the flow of milk and generates signals corresponding to the milking conditions being monitored. The signals are received in the activity-based controller 30 in the milk monitor 20. The activity-based controller 30 may be a programmable logic controller, a personal computer, or a programming operator interface, as examples of devices that respond to milk sensor data to provide variable control parameters to one or more dairy system modules. Operator interface is available through key pads 52, key boards 54, central detacher control buttons 56, individual detacher control buttons 58, warning lights, or even audible alarms. Operator interface enables an operator to adjust milking instructions or receive information from the monitoring system.

Desirably, the activity-based controller 30 includes a base set of milking instructions that are input automatically when an operator responds to queries from the activity-based controller 30 regarding milking conditions, such as the number of daily milkings, cow herd size, milking preferences such as “wet” or “dry”, or others as described above.

Once established, the initial set of milking instructions can be modified by the activity-based controller 30 automatically or manually to optimize milking conditions for each cow, cow quarter, or group of cows in a cow herd. Automatic modifications to dairy facility control parameters can result from input by ambient condition monitors 70 such as: thermometers 71, barometers 72, clocks 73, or calendars 74, or other time sensitive considerations like lactation cycle curves, for example. Further, the activity-based controller 30 has the ability to archive milking curves for individual cows and cow udder quarters. Archived data can be compared to fresh milk data to immediately adjust milk times or vacuum and/or vacuum rate and ratio to accommodate trends in the milk data. Also, if current milk data exceeds acceptable trend ranges, a warning signal can be generated to alert operators or even cause immediate detachment of the milker. Modifications can also result from data received from any dairy facility module such as feed systems 50, vacuum systems 38, chillers 40, sorters 60, etc.

As trend analysis for cows and cow udder quarters becomes more complex, a closed loop logic or fuzzy logic system can be programmed into the activity-based controller 30 to accommodate multiple trends input into the activity-based controller 30 by various sensors or the operator interface. The closed loop system can continually compare current milk data with milk data archives to determine whether results are consistent or whether changes to dairy systems are causing production trends toward an optimum condition.

For example, once a base line of milk data has been acquired for comparison purposes, subsequent milk data can be monitored in view of a changed milking condition, such as milk/rest ratios, either alone or while changing other milking conditions Changing the ratio from 50/50 to 60/40 and comparing milk production to archived milk production may show improved production performance. If so, the ratio will at least be maintained at this level for this particular cow, but it could be further modified to 65/35 or 70/30 for further comparison. When improvements level off or begin to deteriorate, the vacuum ratio will be returned and maintained at the optimum ratio or at least to establish a new base line.

Next, vacuum rate can be modified from a starting point of 12 inches Hg to a higher level and further comparisons made to the new base line data obtained above. Once the optimum vacuum rate is found, vacuum ratio can be revisited or other dairy systems can be modified, such as the degree of wet or dry milking, the number of daily milkings, type of milking liners used, feed conditions, etc. Continual comparisons with archived data will provide optimal dairy system parameters as they relate to individual cows, cow quarters, and to the herd in general. Once optimum system parameters are defined, they can be varied automatically or manually by the activity based controller 30 to accommodate varying ambient conditions, cow estrus cycles, cow health conditions, etc.

The example can be continued by including throughput optimization by grouping cows with similar milking cycles and production histories for simultaneous milking, or even engineering new dairy facilities to accommodate the milking of individual cows without grouping cows to optimize group production at the expense of individual cows. Further, once cow milk data is accumulated and cow milking is optimized, cow breeding can be refined to obtain blood lines having high production with short, or at least more uniform, milking cycles.

This one example of utilizing the present invention illustrates the power of adjustability and data processing when milk data is obtained at the milking machine point of the dairy. All other dairy system modules can become subservient to the milking operation, which is the ultimate indication of dairy performance.

Of course, other ways to optimize milking operations are possible, and the present invention enables dairy operators to select the parameters to be varied depending upon the needs and limitations of that particular dairy. No other system has provided that level of control despite the fact that dairy farmers have always known that individual cows milk out differently and that dairy system components and modules interact to affect dairy production and herd health.

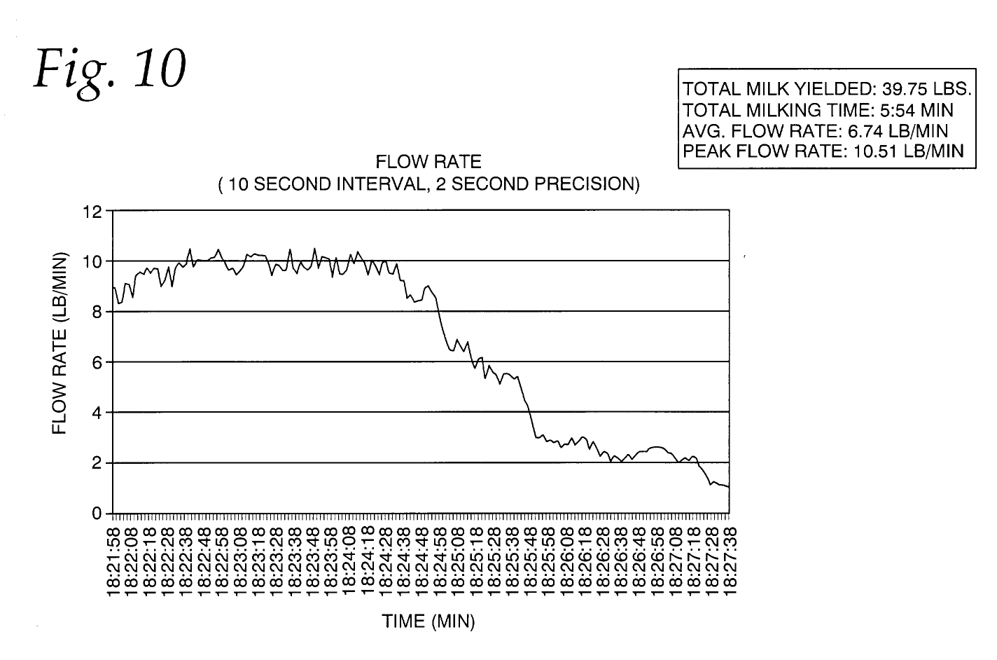

Another example of using the present invention is best explained by reference back to FIG. 10 relating to cow no. 3729. The activity-based controller 30 would receive milk flow rate signals from a milk meter 22 and compare the flow rate to data archives 31 corresponding to this cow which would show a history of relatively high milk production in the first half of the milking cycle with lower yields in the second half of the milking cycle.

The activity-based controller 30 can be programmed to milk out until the full 39 or 40 pounds of milk are produced or for some period in which less milk, but higher dairy throughput are obtained. Further, if the dairy operator chooses to milk more or fewer times per day, the milk cycle may be cut off sooner to optimize throughput and production over time. Further, milk vacuum and milk/rest ratios can be varied to minimize stress on the cow near the end of the milk cycle when the production rate has decreased.

In addition to automatic adjustment of dairy system parameters, a programming operator interface permits an operator to modify parameters or even override base operating parameters altogether. To modify the parameters, an operator can use the programming operator interface to change the number of daily milkings or the degree of wet milking desired. There may be changes in herd size, herd health, or feeding conditions that would be input by an operator. Override may occur when milk data converted by the activity-based controller 30 shows a mechanical malfunction for example. In such an instance, milking may be stopped or extended, as necessary.

The milk monitor 20 preferably includes an automatic override to the manual override because, for example, an operator who manually extends milking time may be distracted and inadvertently neglect a cow on override. Should that occur, the activity-based controller 30 should include a clock limit device or other override instruction that stops milk vacuum when predetermined low milk flow rates are detected, for example.

The programmable activity-based controller 30 may convert milk data signals to control parameters that activate a warning signal should any milking condition vary from desired parameters. The operator warning signal may be used to automatically change milking control parameters such as sounding an audible alarm 56 or activating a visual signal such as a message on a modem 51, lighting on a panel 58, or lighting a button 56. The lighted buttons 56 and 58 preferably require no operator action other than pressing the button, which is desirable under adverse conditions in a dairy. The buttons can be located on individual milker detachers 58 or on a central detacher control board 90.

The warning signals can also be generated in circumstances other than those affecting cow health or equipment malfunction. For example, a warning signal can be used to alert an operator or change individual cow milking control parameters when one or more cows are finished milking and others have not finished. To optimize cow throughput, it may be desirable to stop milking the slow milking cows and move all cows from the milking parlor when one or more is finished milking. This practice does not usually adversely affect cow health, particularly when three or more daily milkings are performed. Similarly, all cow udder quarters can be detached or have vacuum reduced when a single quarter is finished milking. This practice prevents harm to the first quarter milked because no additional milking vacuum is applied after milking is completed, which can cause teat damage. Thus, control parameters in the form of warning signals can be used to automatically adjust milking instructions, alert an operator of any problems or to optimize throughput.

The milk signals can be and are preferably stored in an archive coupled with the activity-based controller 30 so they can be converted to other signals or control parameters that interface with other dairy modules such as the vacuum systems 38, sort systems 60, feed systems 50, milk cooling 42 and storage 44 systems or medical treatment databases.

When used to interface with vacuum systems 38 for example, milk conditions from the cow or cow udder quarters desirably cause changes in vacuum rate and ratio applied by the milker unit. In this manner, vacuum can be adjusted on demand over the course of the milking cycle as proposed generally by Rubino in U.S. Pat. No. 4,572,104, but more specifically on an individual cow or cow quarter basis. With interfacing system modules, cow health is ensured and milking cycles are improved.

Also, milk sensors 22 may detect a health issue for individual cows or cow quarters. When this occurs, it will be necessary to sort the affected cow, preferably with minimal operator involvement. Thus, the milk signal can be converted by the activity-based controller 30 to a sort parameter that will interface with an automatic sort gate system such as Babson Bros.' ProSort™ Gate. When the sort parameter is input into the sort gate system module 60, the sort gate 61 is automatically opened by detector 63 to segregate the affected cow into an appropriate holding pen until any necessary health procedures can take place.

Even healthy cows can be sorted into groups of cows with similar characteristics. For example, as stated above, when a number of cows are being milked simultaneously, it may be desired to optimize throughput by detaching all cows when one or more cows are finished milking. The milk sensor 22 and the activity-based controller 30 identify cows as fast milkers (those milked when detachment occurs) and slow milkers (those not milked to completion when detachment occurs). In this manner, the activity-based controller 30 can covert warning signals generated by slow milkers to sort signals to interface with the sorting module. Slow milkers will then be separated from fast milkers and cows of similar milking cycles or milk times will be grouped and milked together to optimize throughput and milk yield for all cows.

Data acquired by the milk sensors 22 and archived or synthesized in the activity-based controller 30 can be used to provide valuable information to dairy operators, maintenance personnel, equipment dealers, manufacturers, support services, and research facilities. For example, milking sequences can be transmitted upward in a supply chain to maintenance personnel for periodic maintenance or on-time delivery of maintenance supplies. Repeated warning signals from particular milkers or detachers may indicate to operators or equipment suppliers that repairs or redesign are needed. Depleted herd milk production may indicate to operators and veterinarians that there are poor feed conditions or herd health. Equipment monitoring and real-time adjustment of milking instructions may also reveal trends that can be utilized to design better milking equipment by dairy equipment manufacturers. Thus, the activity-based controller sends control parameters and receives data from various system modules to optimize production and herd health.

The ability to make real-time adjustments to milking instructions also permits dairy managers to experiment with varying milking conditions to determine effects on milk yields without varying other milking instructions. In this way, using the present invention, optimum milk yields are obtainable without undue stress on the herd.

The foregoing detailed description of the invention is provided for clearness of understanding only and no unnecessary limitations therefrom should be read into the following claims.

1. A computer-implemented milk monitor, comprising:
a milk sensor for generating signals corresponding to a condition of milk flow from a cow being milked; and
an activity-based controller coupled to the milk sensor to receive the signals and to deliver a milk facility control parameter to a milk facility interface, wherein the activity-based controller comprises a fuzzy logic processor that is coupled to:
a milker detacher and the milk facility control parameter controls when the milk detacher is activated;
a vacuum rate and ratio controller and the milk facility control parameter controls the rate and ratio of milking vacuum; and
a dairy wash system and the milk facility control parameter controls the timing of the milk line wash cycle.

2. The computer-implemented milk monitor of claim 1, wherein the activity-based controller is a data processor.

3. The computer-implemented milk monitor of claim 1, wherein the activity-based controller comprises a programming operator interface.

4. The computer-implemented milk monitor of claim 1, wherein the fuzzy logic processor is coupled to a data archive and the milk facility parameters are responsive to trends in the data archive.

5. The computer-implemented milk monitor of claim I, wherein the fuzzy logic processor is coupled to archived data corresponding to the cow being milked and the milk facility parameters are responsive to comparisons between the milk sensor signals and the archived data.
